(19) United States
(12) Patent Application Publication
(10) Pub. No.: US 2006/0253830 A1
(43) Pub. Date: Nov. 9, 2006

(54) Guiding application building using business constraint metadata

(76) Inventors: Arun Kumar Rajanala, Fremont, CA (US); Ravindar R. Roopreddy, Fremont, CA (US); Weikuo Liaw, Scotts Valley, CA (US)

Correspondence Address: SAWYER LAW GROUP LLP, P.O. BOX 51418, PALO ALTO, CA, 94303, US

(21) Appl. No.: 11/123,980

(22) Filed: May 6, 2005

(51) Int. Cl. G06F 9/44

(52) U.S. Cl. 717/105

(57) ABSTRACT

A computer-implemented method and system are provided for guiding application building using a registry of components, wherein the components are stored as metadata having a reference to one or more saved software procedures that are used to build custom applications. Aspects of the present invention include allowing a user to define an application definition based on business requirements, wherein the application definition comprises a process flow defining a series of process steps, user actions, and domain objects. Each process step identifies one or more domain objects from the business requirements, and each domain object is represented by one or more components in the component registry. A restricted set of components is then created using the components from the component registry that represent the domain objects specified in the application definition. During application building, only access to the restricted set of components is allowed, thereby improving correctness of the application by imposing constraints on the components available to build the application.

### FIELD OF THE INVENTION

The present invention relates to metadata driven application building, and more particularly to a method and system for guiding application building using business constraint metadata that reflect business requirements.

### BACKGROUND OF THE INVENTION

Software application development tools are known that enable a developer to rapidly develop a highly targeted application specific to a customer's needs, or to be able to rapidly customize an existing application. Some application development tools use a framework such as J2EE or .NET, to include component libraries for use in a software development environment, such as JBuilder or VisualC++ to allow a developer to create component-based software applications.

Such software development tools typically maintain a set of component libraries, where each component in the library is represented by its metadata that refers to a pre-compiled procedure that can be reused by different applications. Example types of components include UI components, such as a form, report, or pull-down menu, and business objects. Along with the component libraries, conventional software development tools may also include an application builder engine and a runtime engine. The application builder engine enables a developer to access to the components when building an application and to specify the sequence of how the selected components will be invoked during runtime. Some application builder engines may even guide the user through a component definition process to enable the user to develop a specific instance of a type of component. Once the application definition is complete, the tool stores the application as metadata that refers to the storage locations of the procedures of the corresponding components. At runtime, the application is interpreted by the runtime engine, which invokes the components identified by the metadata in the specified sequence. For example, during execution of the application, one or more components may be invoked that generate a display page requesting the user to enter data into form fields.

Although conventional component-based software development tools may provide advantages over writing actual computer code when developing and implementing the functionality of applications, conventional software development tools do have disadvantages. One disadvantage is that conventional software development tools leave it up to the developer to decide what components are selected for building the application and the sequence that the components are assembled. This means that although some software development tools may allow for integrating and linking to components of the application by checking the language syntax and conformance to the component APIs, conventional tools do not have any knowledge of the business requirements, rules and constraints for which the application is being developed. The result could be an application that has been assembled from selected components, but may not be functionally correct or complete.

Accordingly, what is needed is an improved software development tool for guiding the assembly and creation of new applications using business constraint metadata that incorporates business domain knowledge and application business requirements. The present invention addresses such a need.

### BRIEF SUMMARY OF THE INVENTION

The present invention provides a method and system for guiding application building using a registry of components, wherein the components are stored as metadata having a reference to one or more saved software procedures that are used to build custom applications. Aspects of the present invention include allowing a user to define an application definition based on business requirements, wherein the application definition comprises a process flow defining a series of process steps, user actions, and domain objects. Each process step identifies one or more domain objects from the business requirements, and each domain object is represented by one or more components in the component registry. A restricted set of components is then created using the components from the component registry that represent the domain objects specified in the application definition. During application building, only access to the restricted set of components is allowed.

According to the method and system disclosed herein, the present invention provides an application design tool that improves the correctness of the application by imposing constraints on the components available to build the application. This is in contrast to conventional software development tools that make all components available for selection by the user during application design, which may result in a programmatically correct, but functionally error laden application. Because business constraint metadata is used to confine the application building, the number of assembly errors committed by the developer may be reduced, which may result in less runtime errors.

### BRIEF DESCRIPTION OF SEVERAL VIEWS OF THE DRAWINGS

FIG. 1 is a diagram illustrating a component-based application design tool for guiding a user through component-based application building in accordance with the present invention.

FIG. 2 is a flow diagram illustrating the process for guiding component-base application building with business constraints in a preferred embodiment.

FIG. 3 is a block diagram illustrating an example user interface (UI) workspace for domain editor of the application designer module.

### DETAILED DESCRIPTION OF THE INVENTION

The present invention relates to a method and system for guiding application building using business constraint metadata. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention provides an application design tool for guiding component-based application building that includes a registry of components represented as metadata that are used to build custom applications. According to the present invention, application design data that includes the registry component metadata is extended to include constraint metadata that includes user-specified information about the business domain, application requirements, and customizable rules representing a business solution for a particular custom application. These constraints are then used to guide the developer through the creation and assembly of the custom application by restricting what components are available to the developer for selection.

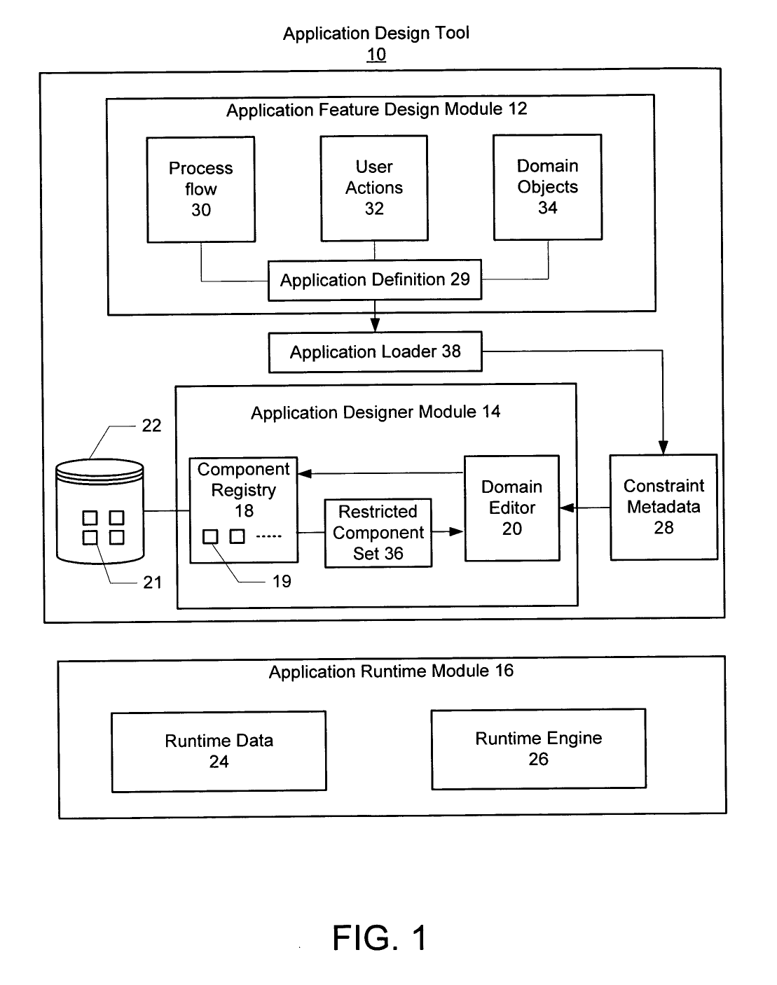

FIG. 1 is a diagram illustrating a component-based application design tool for guiding a user through component-based application building in accordance with the present invention. In a preferred embodiment, the application design tool 10 includes three modules, an application feature design module 12, an application designer module 14, and an application runtime module 16. The application design module 14 includes a component registry 18 containing metadata for components 19, and a domain editor 20. The domain editor 20 provides a user interface workspace that guides a user through the process of building an application using components 19 from the component registry 18, as explained below. The completed application is stored as runtime metadata 24. The runtime engine 26 includes logic for reading the runtime metadata 24 of the completed application at runtime, and invoking the specified components 19.

According to the preferred embodiment, in addition to including a design module 14 for building applications from stored components 19 and a runtime module 16 for executing the components 19 at runtime, the application design tool 10 further includes the application feature design module 12 that allows the user to define an application definition 29 based on business requirements for a custom application. In a preferred embodiment, the application definition 29 comprises a process flow 30 defining a series of process steps, user actions 32, and domain objects 34. More particularly, from a particular set of business requirements representing some business solution, the user defines the process flow 30 for the solution, the action or actions 32 to be performed in each step in the process and the sequence of those actions, and one or more business objects 34 that will be the recipients of the actions 32.

According to a preferred embodiment, the actions 32 may be defined either as role-based or task-based. Role-based actions are defined by identifying the role that will perform the action, such as a submitter, a reconciler, or an approver, for example. Task-based actions are defined by identifying the task to be performed, such as performing a product search, or submitting changes to an approver, for instance.

Domain objects 34 are preferably represented by one or more components 19 in the component registry 18. For example, in a human resources (HR) application, a business object may be an “employee”, and the HR application should have the ability change an employee's salary or position. In this example, the employee object may map to several components 19, such as a person, a role or position, and the relationship between the person and the role. Besides process flow 30, the user actions 32, and domain objects 34, the application definition 29 may also include other information that may be based on customizable rules, and business domain knowledge, for example.

In a preferred embodiment, the components 19 are implemented as object-oriented class templates that are stored as metadata definitions referencing one or more saved software procedures 21 that are invoked at runtime. The software procedures 21 for the components 19 may be stored in a database 22. The component registry 18 may include various types of components 19. Example types of components 19 include 1) user interface components, 2) user interface controls, 3) process steps, 4) user actions, 5) business objects, 6) validators, and 7) business logic rules. User interface components include items that can be displayed in a user interface such as forms, screens, and pages, etc. User interface controls include items that can be displayed on a user interface component, such as buttons, form fields, pull-down lists, etc. Each control may include default renderers and a control property sheet. Process steps are steps that can be performed in the business. User actions are actions that can be performed in the process steps. Business objects are logical groupings of a set of data attributes of a business. A set of business objects may be used to define the business. The behavior of each business object is defined by set of attributes associated with the business object.

Validators are algorithms that can be attached to other components for automatically validating values entered into a form field when the finished application incorporating the form field is executed. An example of a validator function is checking that a value entered onto a data field is entered in mm-dd-yyyy format, for instance. Thus, the metadata for at least a portion of the components 19 may identify the validator(s) associated with the component 19 and the metadata for the requirements provides further constraint by which a validator, if any, should be attached, such that when the component 19 is placed into an application, the validator associated with the component 19 is also automatically added to the application, thus preventing the developer from missing the step during application building.

After the application definition 29 is completed, the design module 14 creates a set of constraint metadata 28 from the application definition 29. The constraint metadata 28 is then applied to the domain editor 20 during assembly of the application to restrict which components 19 from the component registry 18 the domain editor 20 makes available to the user. That is, the constraint metadata 28 instructs the domain editor 20 to only make available those components in the component registry 18 that represent the domain objects specified in the application definition 29 for the custom application. By creating a restricted set of components 36 and only allowing access to the restricted set of components 36 during application building, the application design tool 10 improves the correctness of the application by imposing constraints on the components available to build the application. This is in contrast to conventional software development tools that make all components available for selection by the user during application design, which may result in a programmatically correct, but functionally error laden application.

After the assembly of the application using the restricted set of components 36 is complete, the application may be stored as runtime metadata 24 that specifies the components 36 selected by the user and the order the components 36 are to be invoked. When a user wishes to run the application, the user invokes the runtime engine 26, and specifies the runtime data 24 for the desired application. The runtime engine 26 reads the metadata in the runtime data 24 and invokes the specified components 36 in the order specified. Because business constraints metadata 28 were used to confine the application building, the number of assembly errors committed by the developer is significantly reduced, thereby resulting in a more robust and error-free custom application.

In a preferred embodiment, a vendor of the application design tool 10 designs and creates the component registry 18 during a component design phase and bundles the component registry 18 with the application design tool 10. In a preferred embodiment, the components 19 are designed to be used in a wide range of businesses applications, and the application design tool 10 is made commercially available to customers for use in designing and building custom applications. Although the application design tool 10 may be installed and executed on any type of computer such as a PC or workstation, in a preferred embodiment, the application design tool 10 is installed on server and made available to users over a network, such as an Intranet or the Internet. Elements of the application design tool 10 may be stored and executed on the same or different computers.

In a preferred embodiment, the application design tool 10 is provided to various customers, such as large and small business enterprises, who then define their own business constraints and use those constraints when creating their own component-based custom applications. Although the tool 10 has been described as being operated by “a user”, in a preferred embodiment, the tool 10 may actually be used by different people, in a customer's organization, as described below.

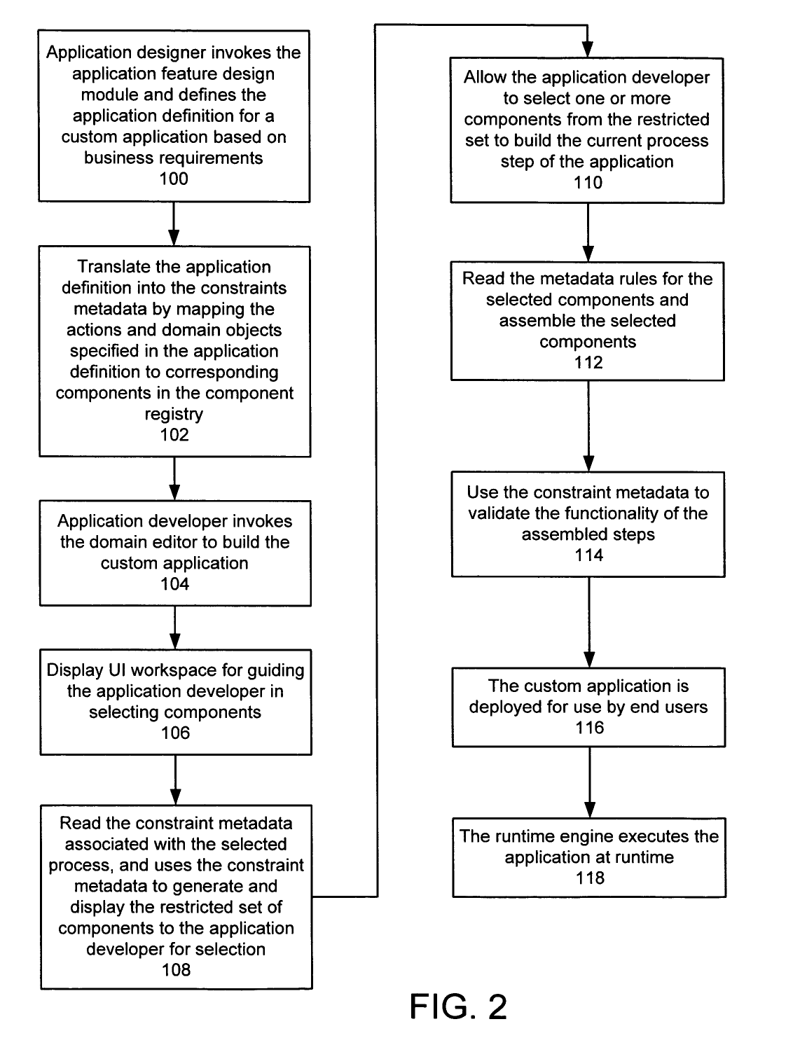

FIG. 2 is a flow diagram illustrating the process for guiding component-base application building with business constraints in a preferred embodiment. The process begins during an application feature design phase in which an application designer of the customer invokes the application feature design module 12 in step 100, and defines the application definition 29 for a custom application based on business requirements. The application designer in this step is preferably a member of a marketing team responsible for deciding the functional requirements for the application. In a preferred embodiment, the application designer creates the application definition 29 by invoking a commercially available workflow tool designer/editor and uses the workflow tool to define the process flow steps and sequence, the actions, and the domain objects. In an alternative embodiment, the application designer may create the application definition 29 using a user interface provided by the domain editor 20. In a preferred embodiment, the completed application definition 29 is stored as a set of XML application configuration files.

In step 102 an application loader 38 (FIG. 1) translates the application definition 29 into the constraints metadata 28 by mapping the actions and domain objects specified in the application definition 29 to corresponding components 19 in the component registry 18 in order to identify the set of components 19 necessary to build each step defined in the process flow. This is accomplished by parsing each step in the process flow to find each specified action and object, and then identifying the components 19 from the component registry 18 that correspond to the specified actions and domain objects. The identified components are then used as the restricted set of components 36 for process that step so that when this step is built during application building, only those components 36 are made available.

During an application building phase, the domain editor 20 of the application design module 14 is invoked in step 104 by another user, preferably by an application developer of the customer. Steps 102 and 104 are order independent in that the constraint metadata 28 may be generated either at the conclusion of the application feature design phase, or at the beginning of the application building phase. In step 106, the domain editor 20 displays a UI workspace that organizes the customer's applications and guides the application developer in selecting components 36 to build the application per the application definition 29 defined by the application designer.

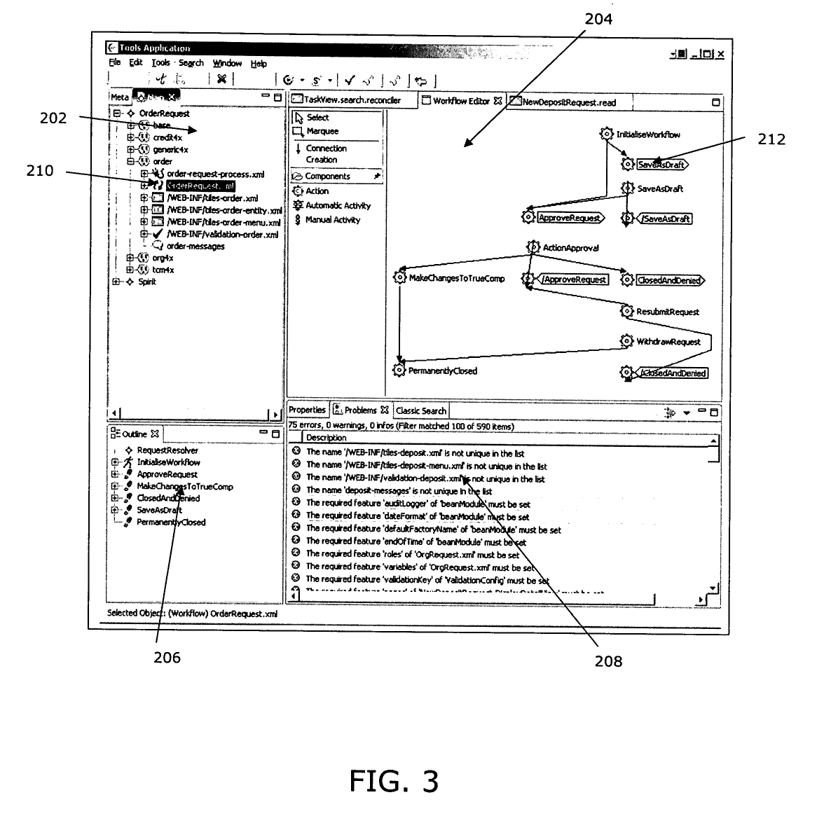

FIG. 3 is a block diagram illustrating an example user interface (UI) workspace for domain editor 20 of the application designer module 14. In an exemplary embodiment, the UI workspace 200 preferably comprises a window that includes four panes, a project pane 202, an editor view 204, an outline view 206, and a diagnostic view 208. The project pane 202 displays the customer's projects folders and files corresponding to applications. Each application may include one or more process flows 210, which may be shown nested beneath the corresponding application. The outline view 206 displays an outline of the projects and/or application process flows. When the application developer clicks on one of the process flows 210 in either the project pane 202 or the outline view 206, each process step 212 in the process flow 210 as defined in the constraint metadata 28 is displayed in the editor view 204 along with an indication of the sequence of the steps. The application developer may then click on one of the steps 212 to select components to build that step 212, where building the step may include creating, modifying, and deleting the step 212.

Referring again to FIG. 2, in response to the developer clicking on one of the steps 212 to select components to build that process step 212, in step 108, the domain editor 20 reads the constraint metadata 28 associated with the selected process step 212, and uses the constraint metadata 28 to generate and display the restricted set of components 36 to the application developer for selection. In step 110, the domain editor 20 allows the application developer to select one or more components from the restricted set 36 to build the current process step of the application. The application developer may also specify particular attributes of the displayed components 36 for inclusion into the application, and specify field validators.

As an example, assume the application developer is building a form authoring flow. The application developer may begin by instantiating the form by browsing for form-type components displayed in the restricted set of components 36. The application developer may then add field controls by selecting control-type components. The application developer may then select and attach validation-type components for the fields. Finally, the application developer may select and attach an initialization rule to a control to specify a rule for parameter data.

In step 112, the domain editor 20 reads the metadata rules for the selected components 36 and assembles the selected components as specified. In a preferred embodiment, steps 108-112 are repeated for each process step defined in the application definition. In step 114, the domain editor 20 validates the assembly and functionality of the application using the constraint metadata 28 to validate the functionality of the assembled steps. For example, when building a form that has ten fields, the domain editor 20 checks that all ten fields were selected by the application builder. The validation results may be displayed in the diagnostic view 208 (FIG. 3) of the UI workspace.

After the functionality of the custom application is validated, the custom application is deployed by the customer for use by end users in step 116. The end-users then access the application runtime module 16 and invoke the application in step 118, which is then executed by the execution engine 26.

A method and system for guiding application building using business constraint metadata has been disclosed. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A computer-implemented method for guiding application building using a registry of components, wherein the components are stored as metadata having a reference to one or more saved software procedures that are used to build custom applications, the method comprising:
allowing a user to define an application definition based on business requirements, wherein the application definition comprises a process flow defining a series of process steps, user actions, and domain objects, wherein each process step identifies one or more domain objects from the business requirements, and wherein the domain objects are represented by one or more components in the component registry;
creating a restricted set of components using the components from the component registry that represent the domain objects specified in the application definition; and
only allowing access to the restricted set of components during application building, thereby improving correctness of the application by imposing constraints on the components available to build the application.

2. The method of claim 1 wherein the creation of the restricted set of components further includes: for each step in the process flow, mapping the actions and domain objects specified in the step to corresponding components in the component registry, and using the identified components as the restricted set of components for the step so that when the step of the process flow is built during application building, only those components are made available.

3. The method of claim 2 further including:
providing the component registry during a component design phase;
allowing the user to create the application definition during an application design feature design phase; and
creating the restricted set of components during an application building phase.

4. The method of claim 3 further including: guiding the user during the application building phase by displaying a user interface workspace that displays the process steps defined for the custom application, wherein for each step, the restricted set of components is displayed for user selection in order to build the step.

5. The method of claim 4 further including: reading metadata rules for the components selected by the user and assembling the selected components as specified.

6. The method of claim 1 wherein the application definition further includes: allowing the user to define the actions as at least one of role-based actions and task-based actions.

7. The method of claim 1 further including: validating assembly and functionality of the application using the application definition to validate the functionality of the assembled steps;
after validating the assembled application, storing the application as runtime metadata that specifies the components selected by the user; and
after the application is deployed for use by an end user, using a runtime engine to run the application, wherein runtime engine reads the metadata in the runtime data and invokes the specified components.

8. The method of claim 1 further including: implementing the components as object-oriented class templates that are stored as metadata definitions referencing one or more saved software procedures that are invoked at runtime, wherein the component registry include different types of components, including any combination of user interface components, user interface controls, process steps, user actions, business objects, and validators, and business logic rules.

9. The method of claim 8 further including: identifying in the metadata for at least a portion of the components, the validator associated with the component, such that when the component is placed into the custom application, the validator associated with the component is automatically added to the application.

10. An application design tool for guiding a user through component-based application building, comprising:
a component registry for storing components as metadata having a reference to one or more saved software procedures;
a first module that enables a user to define an application definition based on business requirements for a custom application;
constraint metadata generated from the application definition;
a second module for guiding the user through a process of building an application using components from the component registry, wherein the constraint metadata is applied to the second module for restricting which components from the component registry are made available during assembly of the application; and
a runtime engine for reading application at runtime and invoking the specified components.

11. The application design tool of claim 10 wherein the constraint metadata is generated by: for each step in the process flow, mapping the actions and domain objects specified in the step to corresponding components in the component registry, and using the identified components as the restricted set of components for the step so that when the step of the process flow is built during application building, only those components are made available.

12. The application design tool of claim 11 wherein the component registry is created during a component design phase.

13. The application design tool of claim 12 wherein a vendor of the application design tool bundles the component registry with the application design tool and makes the application design tool available to customers for designing and building custom applications.

14. The application design tool of claim 13 wherein the first module is invoked during an application design feature design phase to create the application definition.

15. The application design tool of claim 14 wherein the restricted set of components is created during an application building phase.

16. The application design tool of claim 15 wherein the application definition comprises a process flow defining a series of process steps, user actions, and domain objects.

17. The application design tool of claim 10 wherein the second module displays a user interface workspace that displays the process steps defined for the custom application and, for each step, the restricted set of components for user selection in order to build the step.

18. The application design tool of claim 17 wherein the second module reads metadata rules for the components selected by a user and assembling the selected components as specified by the constraint metadata.

19. The application design tool of claim 10 wherein the first module allows a user to define actions as at least one of role-based actions and task-based actions.

20. The application design tool of claim 10 wherein the second module validates assembly and functionality of the application using the constraint metadata to validate the functionality of the assembled steps.

21. The application design tool of claim 20 wherein the second module stores the validated application as runtime metadata that specifies the components selected by the user.

22. The application design tool of claim 21 wherein after the application is deployed for use by an end user, the runtime engine reads the metadata in the runtime data and invokes the specified components.

23. The application design tool of claim 10 wherein the components are implemented as object-oriented class templates that are stored as metadata definitions referencing one or more saved software procedures that are invoked at runtime, wherein the component registry include different types of components, including any combination of user interface components, user interface controls, process steps, user actions, business objects, and validators, and business logic rules.

24. The application design tool of claim 23 wherein the metadata for at least a portion of the components identifies the validator associated with the component, such that when the component is placed into the custom application, the validator associated with the component is automatically added to the application.

25. A computer-readable medium containing program instructions for guiding application building using a registry of components, wherein the components are stored as metadata having a reference to one or more saved software procedures that are used to build custom applications, the program instructions for:
allowing a user to define an application definition based on business requirements, wherein the application definition comprises a process flow defining a series of process steps, user actions, and domain objects, wherein each process step identifies one or more domain objects from the business requirements, and wherein the domain objects are represented by one or more components in the component registry;
creating a restricted set of components using the components from the component registry that represent the domain objects specified in the application definition; and
only allowing access to the restricted set of components during application building, thereby improving correctness of the application by imposing constraints on the components available to build the application.
